(19) United States
(12) Patent Application Publication
(10) Pub. No.: US 2022/0161399 A1
(43) Pub. Date: May 26, 2022

(54) DETACHMENT-PREVENTIVE ADAPTOR SOCKET

(71) Applicant: WEN-HAN PENG, Taichung City (TW)

(72) Inventor: WEN-HAN PENG, Taichung City (TW)

(21) Appl. No.: 16/953,351

(22) Filed: Nov. 20, 2020

(51) Int. Cl. B25B 23/00; B25B 13/06

(52) U.S. Cl. CPC B25B 23/0035; B25B 13/06

(57) ABSTRACT

A detachment-preventive adaptor socket includes a drive portion having an end face that is formed with an axially inward recessed drive hole having multiple axially-extending sidewalls, of which at least two opposite sidewalls are each formed with a radially-recessed detachment-prevention groove, the end face of the drive portion being also formed with a first guide slope that is axially inward recessed and extended as an inclination arranged in an annular form that is connected to the end face of the drive portion and has an outside diameter greater than a diameter of the drive hole, a second guide slop being arranged between each sidewall of the drive hole and the first guide slope and directly adjacent to the first guide slope; and an operation portion, which is axially connected with the drive portion and has an end face that is axially recessed to form an operation hole.

### TECHNICAL FIELD OF THE INVENTION

The present invention relates to an accessory of a drive tool, and more particularly to a detachment-preventive adaptor socket.

### DESCRIPTION OF THE PRIOR ART

To tighten or loosen a nut, in order to make the application of forces easy and accurate, an adaptor socket is used to temporarily connect between the nut and a drive tool so that a rotating power generated by the drive tool can be transmitted through the adaptor socket to the nut to fulfill the purpose of tightening or loosening the nut.

However, as shown in FIGS. 1 and 2, a connection fitting tool 1 disclosed in Taiwan Patent No. 1690302 is provided. The connection fitting tool 1 is fit and attached to a drive head 91 of a drive tool 90. The drive head 91 has an outer circumferential surface on which a retaining clip 92 (such as a C-clip). The connection fitting tool 1 comprises a connection portion 2 and an operation portion 3. The connection portion 2 includes a receiving trough 4 that is formed as being recessed from a top face. The receiving trough 4 has side surfaces 5 that include a plane generally parallel to an axial direction (axis line). The receiving trough 4 has a bottom surface that is a conic surface (namely a slope surface). The receiving trough 4 receives a retaining clip 92 of the drive head 91 to position therein. The connection portion 2 also includes a polygonal hole 7 that extends through the receiving trough 4. The polygonal hole 7 receives the drive head 91 to position therein. The operation portion 3 includes an operation hole 8. The operation hole 8 can be fit to and coupled with a nut. As such, to connect the drive head 91 with the connection fitting tool 1, the retaining clip 92 of the drive head 91 is first put into the receiving trough 4 of the connection fitting tool 1 (as shown in FIG. 1), to allow a user to easily rotate the drive head 91 to align with the polygonal hole 7. After being so aligned, the drive head 91, together with the retaining clip 92, is pushed into the polygonal hole 7 (as shown in FIG. 2), to fulfill the function of fast fitting and connection.

Although the retaining clip 92 of the above-described drive head 91 is forcibly fit into the polygonal hole 7 of the connection fitting tool 1, the sidewalls of the polygonal hole 7 are generally flat surfaces and the retaining clip 92 is a C-clip that possess a property of moderate elastic deformation, so that during the rotation of the drive head 91, once the retaining clip 92 is slightly compressed and thus deformed, it is likely that the retaining clip 92, together with the drive head 91, to slip off the polygonal hole 7 of the connection fitting tool 1 (meaning the connection fitting tool 1 is separated from the drive head 91). This not only causes a situation of being unsmooth in operation, but also, in a worse condition, makes the connection fitting tool 1 to quickly throw out, leading to injury to the user, this being a concern of operation safety.

Further, the above-described connection fitting tool 1 is structured such that the receiving trough 4 is provided to allow a front end portion of the retaining clip 92 provided on the drive head 91 to enter first for disposition therein, in order to enable the subsequent operations of rotation, alignment, and push-in. However, the side surfaces 5 of the receiving trough 4 are planes that are generally parallel to the axial direction (the axis line), and this needs to remove extra material therefrom during fabrication, leading to a waste of material and reduction of stiffness, and also causing concerns of shaking and loosening during joint rotation of the drive head 91 and the connection fitting tool 1.

### SUMMARY OF THE INVENTION

In view of the above, to alleviate the problems of the known connection fitting tool as being undesirably detachable from a drive tool to cause concerns of operation safety and unsmooth driving and those of material waste and reduced stiffness and strength resulting from the sidewalls of the receiving trough being formed as planes that are parallel to the axis line, the present invention provide a detachment-preventive adaptor socket, which comprises: a drive portion, which has an end face that is axially inward recessed and extended to form a drive hole, the drive hole having multiple sidewalls extending in an axial direction, at least two of the multiple sidewalls that are opposite to each other being each formed with a radially-recessed detachment-prevention groove, the end face of the drive portion being axially inward recessed and extended to form a first guide slope formed an inclination arranged in an annular form, the first guide slope having a top end that is joined with the end face of the drive portion, the first guide slope having an outside diameter that is greater than a hole diameter of the drive hole, a second slope that is inclining being formed between a top end of each of the sidewalls of the drive hole and a bottom end of the first guide slope, the second guide slope being directly adjacent to the first guide slope; and a operation portion, which is axially connected with the drive portion, the operation portion having an end face that is axially inward recessed and extended to form an operation hole, so as to achieve the advantages of preventing undesirable detachment from a drive head, increasing operation safety, enhancing operation smooth of a driving operation, reducing waste of material, and enhancing stiffness.

The present invention also provides a detachment-preventive adaptor socket, which comprises: a drive portion, which has an end face that is axially inward recessed and extended to form a drive hole, the drive hole having multiple sidewalls extending in an axial direction, at least two of the multiple sidewalls that are opposite to each other being each formed with a radially-recessed detachment-prevention groove, a guide slope that is extended in an inclining manner and is gradually expanded outward being formed between a top of each of the multiple sidewalls and the end face of the drive portion, an imaginary line of outward extension of the guide slope being set at an angle of 40 degrees to 80 degrees relative to the end face of the drive portion; and an operation portion, which is axially connected with the drive portion, the operation portion having an end face that is axially inward recessed and extended to form an operation hole, so as to achieve the advantages of preventing undesirable detachment from a drive head, increasing operation safety, enhancing operation smooth of a driving operation, reducing waste of material, and enhancing stiffness.

### BRIEF DESCRIPTION OF THE DRAWINGS

FIG. 1 is a schematic view showing a structure of a known connection fitting tool.

FIG. 2 is a schematic view demonstrating an operation of connecting the known connection fitting tool shown in FIG. 1 to a drive tool.

FIG. 3 is a perspective view showing a first preferred embodiment according to the present invention.

FIG. 4 is a perspective view, in a sectioned form, showing the embodiment of FIG. 3.

FIG. 5 is a cross-sectional view, taken along an axial direction, showing the embodiment of FIG. 3.

FIGS. 6 and 7 are schematic views demonstrating an operation of connecting the embodiment of FIG. 3 to a drive tool.

FIG. 8 is a perspective view showing a second preferred embodiment according to the present invention.

FIG. 9 is a cross-sectional view, taken along an axial direction, showing the embodiment of FIG. 8.

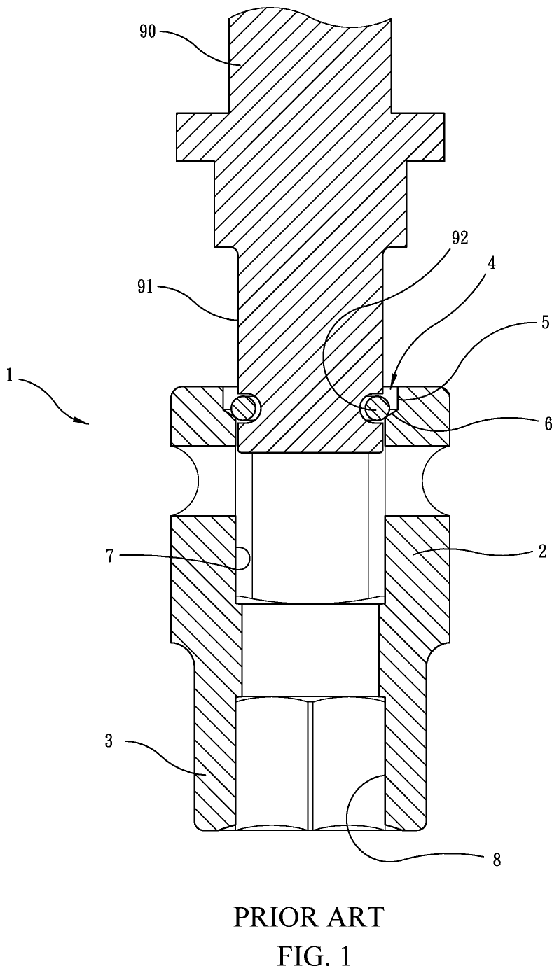

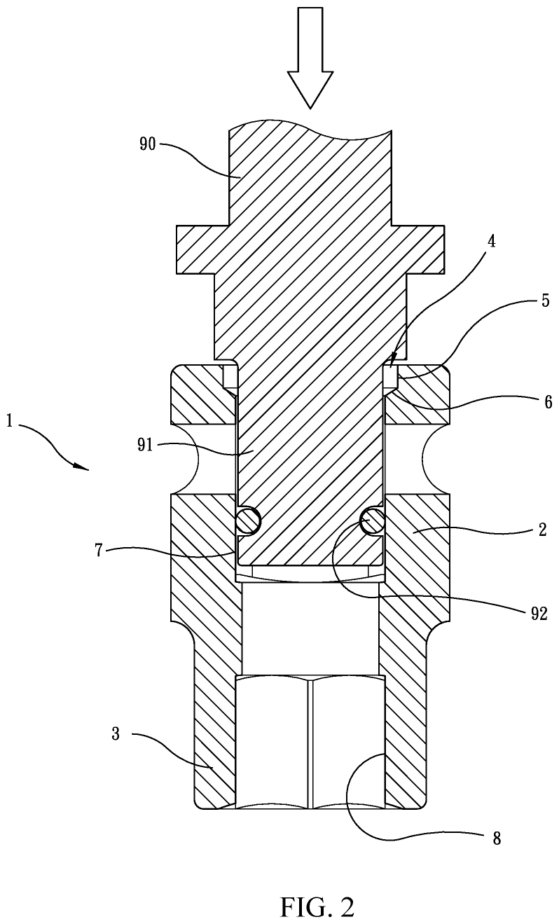

### DETAILED DESCRIPTION OF THE PREFERRED EMBODIMENT

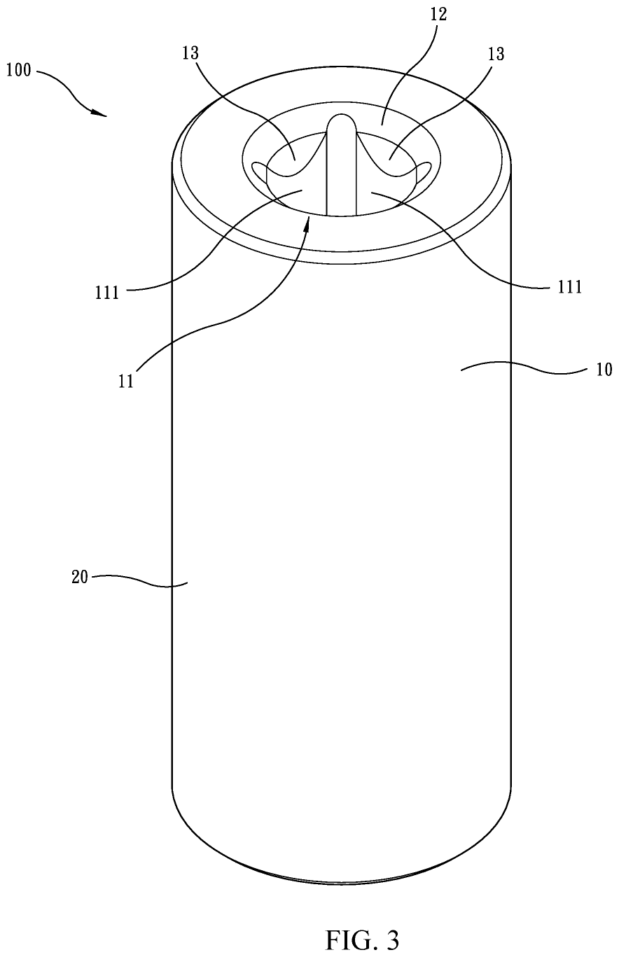

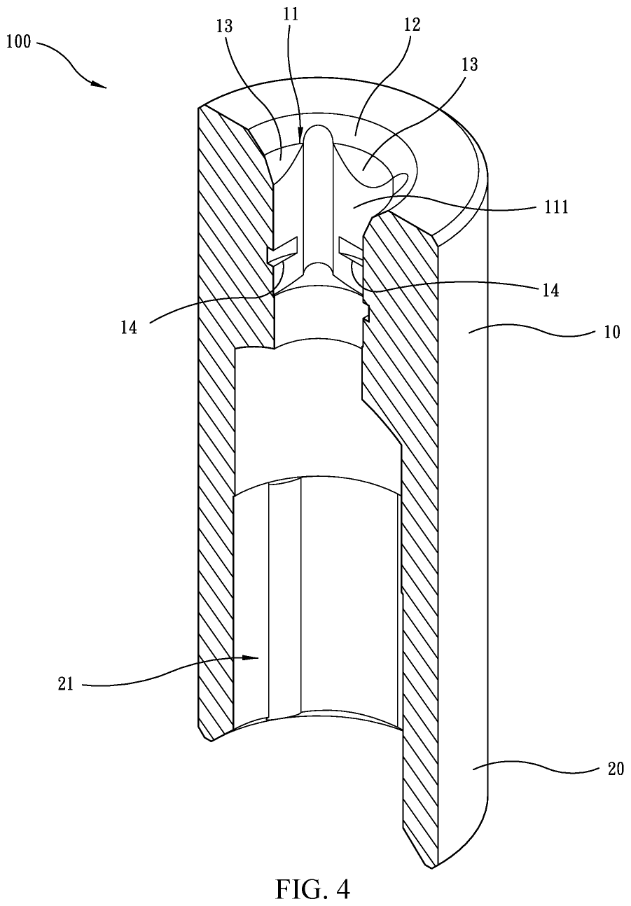

Referring to FIGS. 3-7, a first preferred embodiment of the present invention provides a detachment-preventive adaptor socket 100, which is formed integrally as a one piece and mainly comprises a drive portion 10 that is formed at one end the and an operation portion 20 that is integrally and coaxially connected with the drive portion 10 and is formed at an opposite end.

Referring to FIGS. 3-5, the drive portion 10 has an end face (namely a surface of a free end thereof) in which a drive hole 11 is formed through axially inward recessing and extending. The drive hole 11 is a regular quadrilateral hole (or a quadrangular hole) having four sidewalls 111 extending in the axial direction. The drive portion 10 is also formed in the same end face, through axially inward recessing and extending, with a first guide slope 12 that is inclination arranged in an annular form. The first guide slope 12 has a top end that is joined with the end face of the drive portion 10. The first guide slope 12 has an outside diameter that is greater than a hole diameter of the drive hole 11. A second guide slope 13, which is made inclining, is formed between a top end of each of the sidewalls 111 of the drive hole 11 and a bottom end of the first guide slope 12, and the second guide slope 13 is directly adjacent to and joined with the first guide slope 12. Each of the sidewalls 111 of the drive hole 11 is formed with a detachment-prevention groove 14 that is formed through recessing in a radial direction.

Referring to FIGS. 3-5, the operation portion 20 is integrally and coaxially connected with the drive portion 10 as a one-piece structure. The operation portion 20 has an end face (namely a surface of a free end thereof) in which an operation hole 21 is formed through axially inward recessing and extending. The operation hole 21 is a hexagonal hole. The operation portion 20 has an outside diameter that corresponds to an outside diameter of the drive portion 10. The operation hole 21 is made in communication with and connected to the drive hole 11.

As such, the above provides a description to components, and assembly thereof, of the detachment-preventive adaptor socket 100 according to the first preferred embodiment of the present invention, and a description to the operation thereof will be provided below.

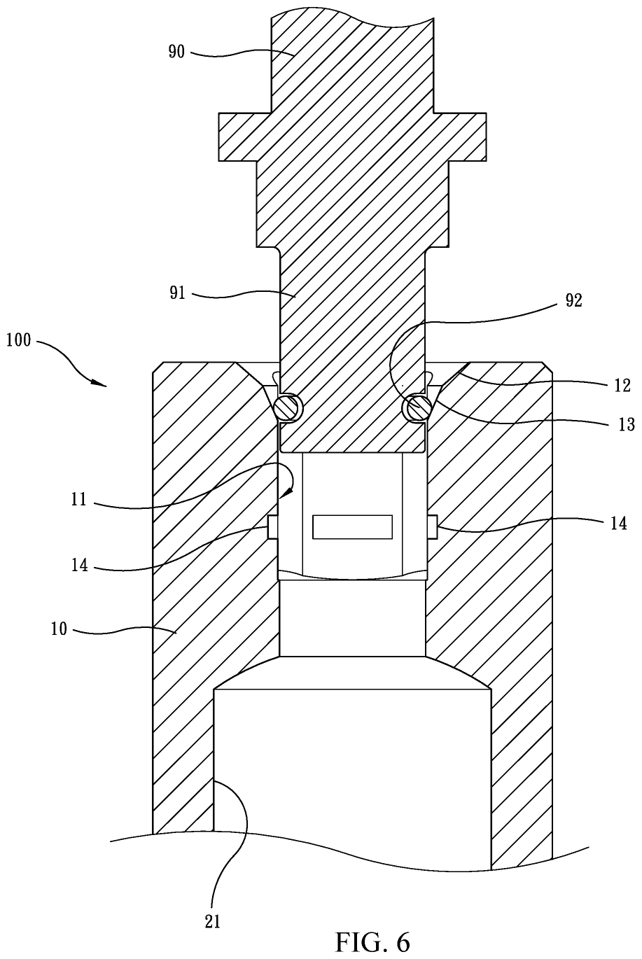

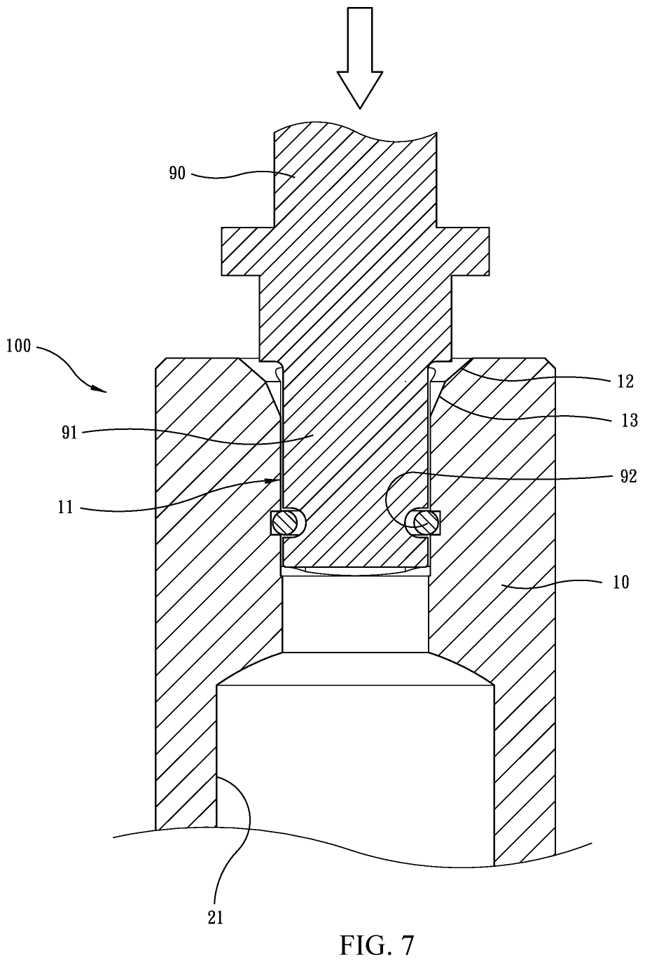

Firstly, referring to FIGS. 6 and 7, to connect the present invention with a drive head 91 of a drive tool 90, since a retaining clip 92 is provided on a circumferential surface of the drive head 91 at a location adjacent to an end thereof, the retaining clip 92 is first moved along the first guide slope 12 to be inwardly introduced to pass through the first guide slope 12, and is then moved inward onto the second guide slope 13 (as shown in FIG. 6), followed by slight rotation of the present invention to align the drive head 91 with the drive hole 11. Then, a force is applied to push the drive head 91, together with the retaining clip 92, into the drive hole 11, forcing the retaining clip 92 to fit into and get in retaining engagement with the detachment-prevention groove 14 (as shown in FIG. 7), such that the drive head 91 is tightly fit into and retained in the drive hole 11. As such, the operation hole 21 of the operation portion 20 can be fit onto a nut, bolt, or female fastener (not shown), so that the detachment-preventive adaptor socket 100 of the present invention may transmit a rotating power generated by the drive head 91 of the drive tool 90 to the nut, bolt, or female fastener to carry out a tightening or loosening operation. When the user attempts to separate the present invention from the drive head 91, the user may apply a force to pull the present invention outward so as to force the retaining clip 92 to contract inward first to disengage from the detachment-prevention groove 14, until being moved out of the drive hole 11.

In this way, since, in this invention, each of the sidewalls 111 of the drive hole 11 is provided with one radially-recessed detachment-prevention groove 14, during an operation that the present invention is employed to tighten or loosen a nut, bolt, or female fastener, the retaining clip 92 is kept and retained in the detachment-prevention grooves 14 to prevent the present invention from unexpectedly or undesirably detaching from the drive head 91.

Thus, in this invention, each of the sidewalls 111 of the drive hole 11 is provided with one radially-recessed detachment-prevention groove 14 to allow the retaining clip 92 to be fit into and securely retained in the detachment-prevention groove 14, so that the present invention is prevented from undesirably detaching from the drive head 91 to thereby provide better and more complete operation security and ensure a smoother process of operation.

Further, the present invention is structured to arrange the first guide slope 12 and the second guide slope 13 connected thereto sequentially between the end face of the drive portion 10 and the sidewalls 111 of the drive hole 11 to ease the introduction and disposition of the retaining clip 92 therein and facilitate alignment of the drive head 91. Further, the arraignment of two slopes helps reduce the amount of removed material so as to not only reduce material waste but also to improve overall stiffness and strength. Shaking or loosening between the present invention and the drive head can also be alleviated to reduce the occurrence of potential risk.

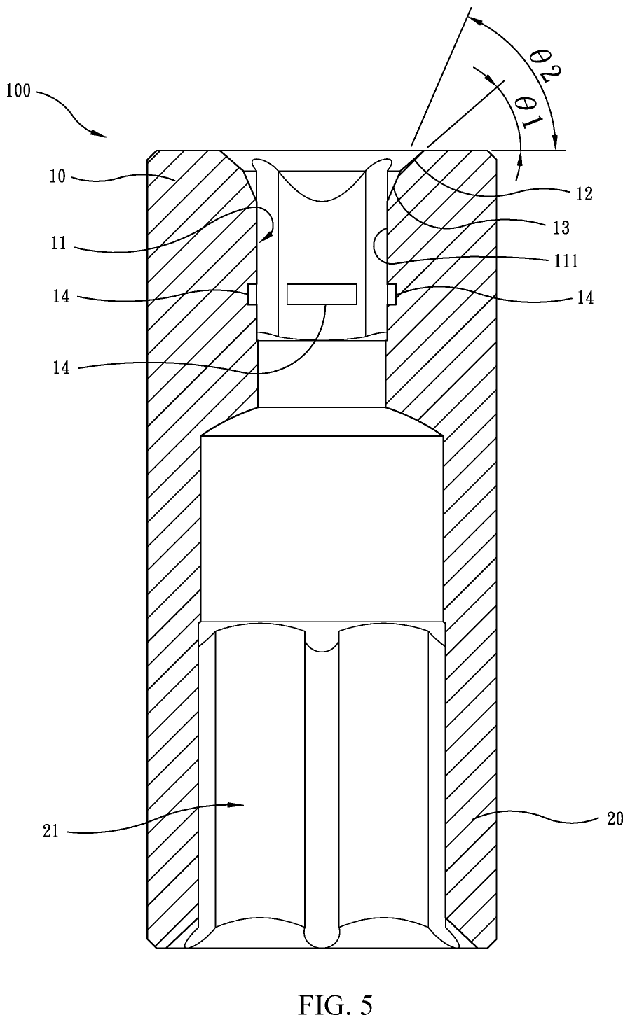

In the above embodiment, as shown in FIG. 5, an imagery line of outward extension of the first guide slope 12 is at an angle θ1 of 15 degrees to 45 degrees relative to the end face of the drive portion 10. An imaginary line of outward extension of the second guide slope 13 is at an angle θ2 of 40 degrees to 80 degrees relative to the end face of the drive portion 10. The ranges of inclination angles of the first guide slope 12 and the second guide slope 13 provided above help fulfill the advantages of leading in, reducing removed material, and alleviating loosening relative to the drive head.

Further, although in the above embodiment, the operation hole is described as a hexagonal hole, yet in actuality, the operation hole can also be any one of a quadrangular hole, an octagonal hole, a dodecagonal hole, or a six-angle star-shaped hole.

Further, although in the above embodiment, the outside diameters of the drive portion and the operation portion are made identical to each other, yet in actuality, the outside diameter of the drive portion can be made greater than the outside diameter of the operation portion, or the outside diameter of the drive portion is smaller than the outside diameter of the operation portion, or the drive hole and the operation hole are not connected to and not in communication with each other, all these being not affecting the effectiveness of the present invention.

Although in the above embodiment, the drive hole of the drive portion is constructed to provide a detachment-prevention groove in each of the sidewalls, yet in actuality, there may be only two opposite sidewalls that are provided with the detachment-prevention grooves, this being sufficient to achieve the effectiveness of the present invention, while allowing the present invention to be used with drive heads of other types, widely expanding the range of application of the present invention.

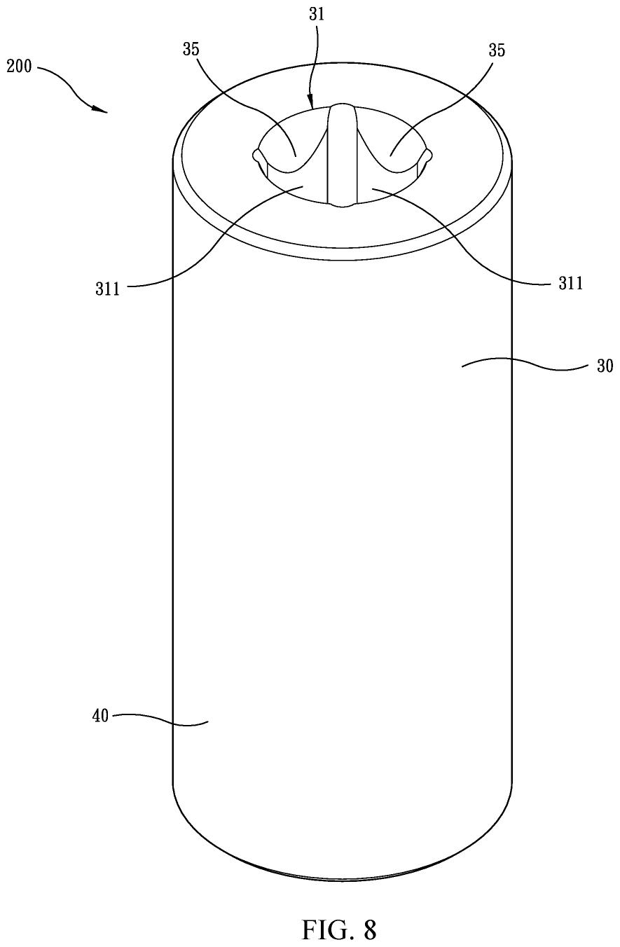

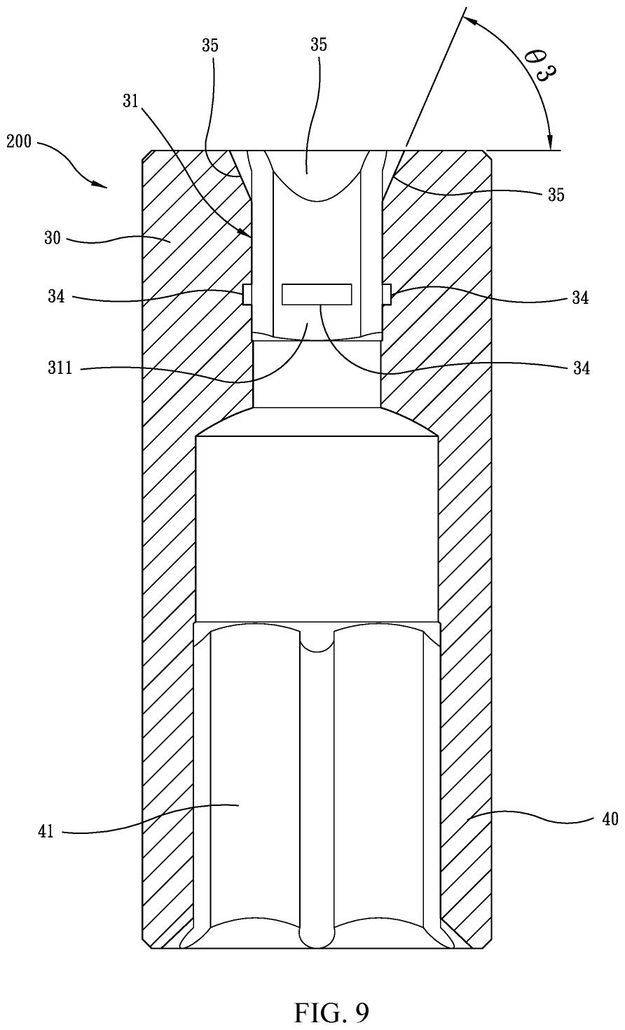

Referring to FIGS. 8 and 9, a second preferred embodiment of the present invention provides a detachment-preventive adaptor socket 200, which, similar to the above-described embodiment, comprises a drive portion 30 and an operation portion 40.

The drive portion 30 has an end face (namely a surface of a free end thereof) in which a drive hole 31 is formed through axially inward recessing and extending. The drive hole 31 is a regular quadrilateral hole having four sidewalls 311 extending in an axial direction. A guide slope 35, which is extended in an inclining manner and is gradually expanded outward, is formed between a top of each of the sidewalls 311 and the end face of the drive portion 30. An imagery line of outward extension of the guide slope 35 is at an angle θ3 of 40 degrees to 80 degrees relative to the end face of the drive portion 30. At least two opposite ones of the sidewalls 311 the drive hole 31 are each formed with a detachment-prevention groove 34 that is formed through recessing in a radial direction.

Referring to FIGS. 8 and 9, the operation portion 40 is integrally and coaxially connected with the drive portion 30 as a one-piece structure. The operation portion 40 has an end face (namely a surface of a free end thereof) in which an operation hole 41 is formed through axially inward recessing and extending. The operation hole 41 is a hexagonal hole.

Thus, although the instant embodiment is structured to provide a guide slope that involves just one specific inclination, which is different from the structure of the first embodiment that involves a combination of two inclinations respectively designated with the first guide slope and the second guide slope, yet both achieve the same effectiveness.

I claim:

1. A detachment-preventive adaptor socket, comprising:
a drive portion, which has an end face that is axially inward recessed and extended to form a drive hole, the drive hole having multiple sidewalls extending in an axial direction, at least two of the multiple sidewalls that are opposite to each other being each formed with a radially-recessed detachment-prevention groove, the end face of the drive portion being axially inward recessed and extended to form a first guide slope formed an inclination arranged in an annular form, the first guide slope having a top end that is joined with the end face of the drive portion, the first guide slope having an outside diameter that is greater than a hole diameter of the drive hole, a second slope that is inclining being formed between a top end of each of the sidewalls of the drive hole and a bottom end of the first guide slope, the second guide slope being directly adjacent to the first guide slope; and
an operation portion, which is axially connected with the drive portion, the operation portion having an end face that is axially inward recessed and extended to form an operation hole.

2. The detachment-preventive adaptor socket according to claim 1, wherein the drive hole is a regular quadrilateral hole having four sidewalls extending in the axial direction.

3. The detachment-preventive adaptor socket according to claim 2, wherein each of the sidewalls of the drive hole is formed with one radially-recessed detachment-prevention groove.

4. The detachment-preventive adaptor socket according to claim 1, wherein the operation hole is one of a quadrangular hole, a hexagonal hole, an octagonal hole, a dodecagonal hole, and a six-angle star-shaped hole.

5. The detachment-preventive adaptor socket according to claim 1, wherein an imaginary line of outward extension of the first guide slope is set at an angle of 15 degrees to 45 degrees relative to the end face of the drive portion; and an imaginary line of outward extension of the second guide slope is at an angle of 40 degrees to 80 degrees relative to the end face of the drive portion.

6. A detachment-preventive adaptor socket, comprising:
a drive portion, which has an end face that is axially inward recessed and extended to form a drive hole, the drive hole having multiple sidewalls extending in an axial direction, at least two of the multiple sidewalls that are opposite to each other being each formed with a radially-recessed detachment-prevention groove, a guide slope that is extended in an inclining manner and is gradually expanded outward being formed between a top of each of the multiple sidewalls and the end face of the drive portion, an imaginary line of outward extension of the guide slope being set at an angle of 40 degrees to 80 degrees relative to the end face of the drive portion; and
an operation portion, which is axially connected with the drive portion, the operation portion having an end face that is axially inward recessed and extended to form an operation hole.

7. The detachment-preventive adaptor socket according to claim 6, wherein the drive hole is a regular quadrilateral hole having four sidewalls extending in the axial direction.

8. The detachment-preventive adaptor socket according to claim 7, wherein each of the sidewalls of the drive hole is formed with one radially-recessed detachment-prevention groove.

9. The detachment-preventive adaptor socket according to claim 6, wherein the operation hole is one of a quadrangular hole, a hexagonal hole, an octagonal hole, a dodecagonal hole, and a six-angle star-shaped hole.
